(19) United States
(12) Patent Application Publication
(10) Pub. No.: US 2003/0229898 A1
(43) Pub. Date: Dec. 11, 2003

(54) Multiple on-demand media vendor integration

(76) Inventors: Suresh P. Babu, Cupertino, CA (US); Amod Dattatray Deshpande, Sunnyvale, CA (US); Yogananda Rao, Sunnyvale, CA (US)

Correspondence Address: LEE & HAYES PLLC, 421 W RIVERSIDE AVENUE SUITE 500, SPOKANE, WA, 99201

(21) Appl. No.: 10/163,649

(22) Filed: Jun. 5, 2002

(51) Int. Cl. H04N 7/173; H04N 7/025; H04N 7/10; H04N 5/445; H04N 7/16

(52) U.S. Cl. 725/87; 725/34; 725/46; 725/1; 725/91

(57) ABSTRACT

A media distribution system receives program data describing on-demand media content available from multiple vendors. The media distribution system packages the program data as electronic program guide data and distributes the electronic program guide data to one or more client devices.

### TECHNICAL FIELD

This invention relates to television entertainment architectures that support multiple on-demand media vendors.

### BACKGROUND

Many existing television entertainment systems are configured to provide video-on-demand (VOD) support, including purchasing, billing, and streaming. Different VOD vendors use different stream protocols and different listing schemas. VOD vendors may also differ in the technical features offered, such as different audio formats, whether or not subtitles are offered, the number of simultaneous streams that are available, and trick modes that are supported (e.g., pause, fast forward, rewind, etc.). There are multiple VOD vendors currently capable of providing services to specific television distribution systems. Although it would be advantageous to the television distribution system operators and the viewers to be able to interact with multiple VOD vendors, current systems are only configured to support one VOD vendor, due to the unique architecture and protocols that each VOD vendor uses. Moreover, although it would be advantageous for both viewers and operators to be able to add new VOD vendors to gain access to additional content libraries and services, the current architectures do not support the addition of a second VOD vendor.

### SUMMARY

An extensible architecture that supports distribution of on-demand media content from multiple vendors is described. The multi-vendor media content architecture has a system to receive information describing on-demand media content available from multiple media vendors. The system distributes a combined list of on-demand media content available from the multiple media vendors to one or more client devices. Support for particular on-demand media vendors may be dynamically added to or removed from the system.

### BRIEF DESCRIPTION OF THE DRAWINGS

The same numbers are used throughout the drawings to reference like features and components.

FIG. 1 illustrates an exemplary multiple vendor on-demand media distribution environment.

FIG. 2 illustrates an exemplary video-on-demand electronic program guide user interface display listing available on-demand media content.

FIG. 3 illustrates an exemplary video-on-demand electronic program guide user interface display of selected media content details.

FIG. 4 is a block diagram of selected components of a media distribution system.

FIG. 5 illustrates an exemplary format for structuring program data received from multiple VOD vendors.

FIG. 6 is a block diagram of selected components of an exemplary EPG data repository schema.

FIG. 7 is a block diagram of selected components of a client device.

FIG. 8 illustrates a method for packaging program data received from multiple video-on-demand vendors for distribution as electronic program guide data.

FIG. 9 illustrates a method for enabling a television viewer to purchase on-demand media content.

FIG. 10 illustrates a method for processing a viewer-submitted request to purchase on-demand media content.

### DETAILED DESCRIPTION

The following discussion is directed to television-based entertainment systems that support on-demand media content from multiple vendors, such as interactive TV networks, cable networks that utilize electronic program guides, and Web-enabled TV networks. Client devices in such systems range from full-resource clients with substantial memory and processing resources, such as TV-enabled personal computers and TV recorders equipped with hard-disks, to low-resource clients with limited memory and/or processing resources, such as traditional set-top boxes. While aspects of the described systems and methods can be used in any of these systems and for any types of client devices, they are described in the context of the following exemplary environment.

Exemplary Environment

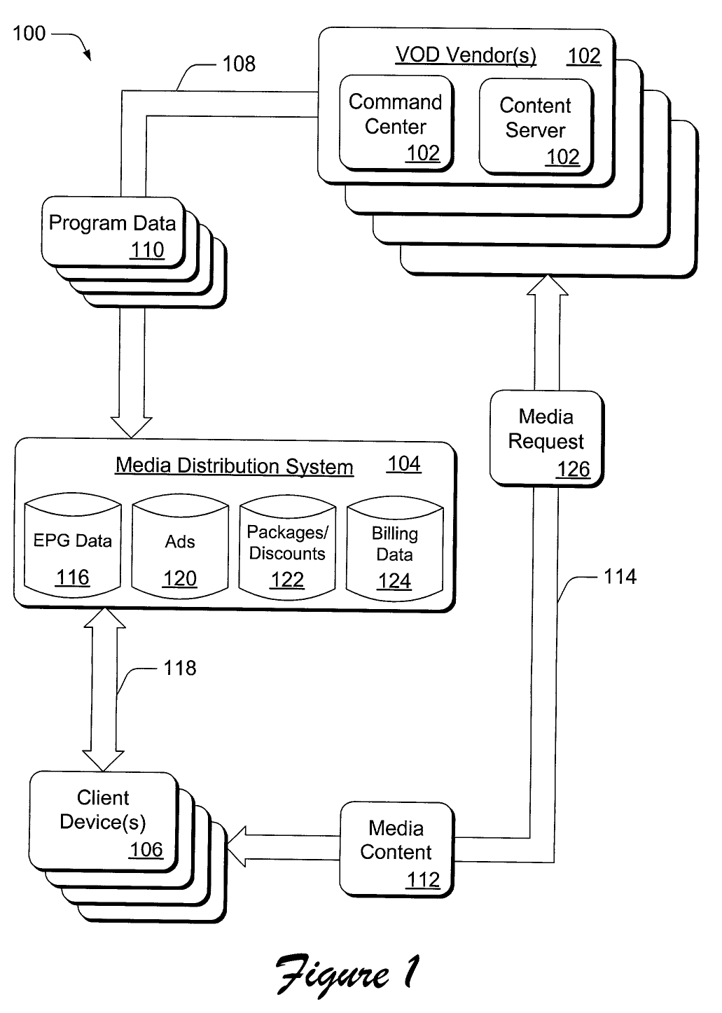

FIG. 1 illustrates an exemplary environment 100 in which an extensible architecture that supports distribution of on-demand media content from multiple vendors may be implemented. Exemplary environment 100 is a television entertainment system that facilitates distribution of on-demand media content from multiple media vendors to multiple viewers. The environment 100 includes multiple video-on-demand (VOD) vendors 102, a media distribution system 104, and one or more client devices 106. The VOD vendors 102, the media distribution system 104, and the client devices 106 communicate via networks 108, 114, and 118.

VOD vendors 102 distribute, to the media distribution system 104, program data 110 describing media content (e.g., movies) that is available on-demand from the VOD vendors 102. Program data may include program titles, ratings, characters, descriptions, actor names, station identifiers, channel identifiers, schedule information, and so on. The program data can be used to generate an electronic program guide (EPG).

VOD vendors 102 also distribute on-demand media content 112 to one or more client devices 106. The program data 110 is distributed to the media distribution system 104 across network 108. The on-demand media content 112 is distributed to client device 106 across network 114.

Media distribution system 104 receives program data 110 from multiple VOD vendors 102. Media distribution system 104 harmonizes the received program data 110 into a common format and packages and stores the program data 110 as EPG data 116. The packaging performed by the media distribution system 104 may include inserting additional information associated with the described media content, generating recommendations for other media content, generating special offers, and so on. The media distribution system 104 may maintain or have access to a data repository that stores data associated with media content. This data may be packaged with the program data 110 received from the VOD vendors 102 to enhance the stored EPG data 116. The packaged EPG data 116 is distributed by the media distribution system 104 over another network 118 to the one or more client devices 106.

Media distribution system 104 also stores advertisements 120, packages and/or discounts 122, and billing data 124. Advertisements 120 may be associated with one or more VOD vendors 102 or with one or more instances of media content. Example advertisements may include media content recommendations and movie previews and/or trailers. Advertisements such as recommendations may be generated by the media distribution system 104. Advertisements such as movie previews and/or trailers may be received from the VOD vendors 102 as part of program data 110.

Packages and discounts 122 may include an offer of multiple media content instances (e.g., a group of three movies) as a single purchasable item. For example, three James Bond movies may be packaged together as a single James Bond Weekend Special item. Multiple vendor support enables the media distribution system 104 to generate packages that offer media content from a plurality of media vendors. For example, the described James Bond Weekend Special package may include three James Bond movies, one from each of three VOD vendors 102. Discounts enable the media distribution system 104 to offer on-demand media content to television viewers at discounted rates.

Another package may be a media-on-demand subscription. By purchasing a subscription, a viewer may be allowed access to a premium channel, such as HBO for a limited time and/or for a maximum number of viewing hours. For example, a viewer may be able to purchase a limited HBO subscription that provides the viewer with the right to view up to 30 instances of any combination of movies and HBO licensed programs (e.g., “Sex in the City” and “The Sopranos”) during a month, with a maximum viewing time of 65 hours. The viewer would be charged monthly for the subscription.

Other packages may be similar to a subscription, but with a shorter time period and not recurring. For example, a viewer may purchase a James Bond Weekend Package that allows the viewer to view up to 10 different movies starring James Bond over a two or three day period. Another example of a package may be a subscription extension. For example, a viewer may purchase an HBO subscription as described above, but want to watch more than the allowed viewing hours in a particular month. When the viewer exceeds the subscription limits, they may purchase an extension package that allows them to view additional content for the current month only.

Media distribution system 104 distributes advertisements 120 and packages and discounts to client devices 106.

Billing data 124 stores data associated with viewer purchases of on-demand media content. The billing data 124 may be collected from the one or more client devices 106 and dispersed to the appropriate VOD vendors 102. Additionally, client devices 106 can request billing data associated with viewer purchases of on-demand media content from one or more VOD vendors 102.

Client device 106 receives packaged EPG data 116 from the media distribution system 104. The client device 106 presents the EPG data 116 in an onscreen program guide that enables a television viewer to navigate through the EPG data 116 to locate available on-demand media content that is of interest to the viewer. When a television viewer submits an order for on-demand media content, the client device transmits a media request 126 to the appropriate VOD vendor 102.

Client device(s) 106 can be implemented in any number of ways. For example, client device 106 may be implemented as a satellite receiving device to receive media content from a satellite-based transmitter via a satellite dish. Alternatively, client device 106 may be implemented as a set-top box to receive media content across a network and provide the received content to an associated television. An exemplary client device may be implemented as a set-top box with an integrated digital video recorder (DVR) application. A particular client device 106 can be coupled to any number of televisions and/or similar devices that can be implemented to display or otherwise render content (e.g., audio data, video data, and a graphical user interface). Similarly, any number of client devices 106 can be coupled to a television. In alternate implementations, client devices 106 may receive broadcast signals via the Internet or any other broadcast medium.

Networks 108, 114, and 118 can include a cable television network, RF, microwave, satellite, and/or data network, such as the Internet, and may also include wired or wireless media using any communication format and/or protocol. Additionally, networks 108, 114, and 118 can be any types of networks, using any type of network topology and any network communication protocol, and can be represented or otherwise implemented as a combination of one or more networks.

Environment 100 can include any number of VOD vendors coupled to any number of media distribution systems and any number of client devices. Furthermore, the environment 100 facilitates an extensible architecture in that support for particular VOD vendors may be dynamically added to or removed from the system.

Exemplary User Interface Display

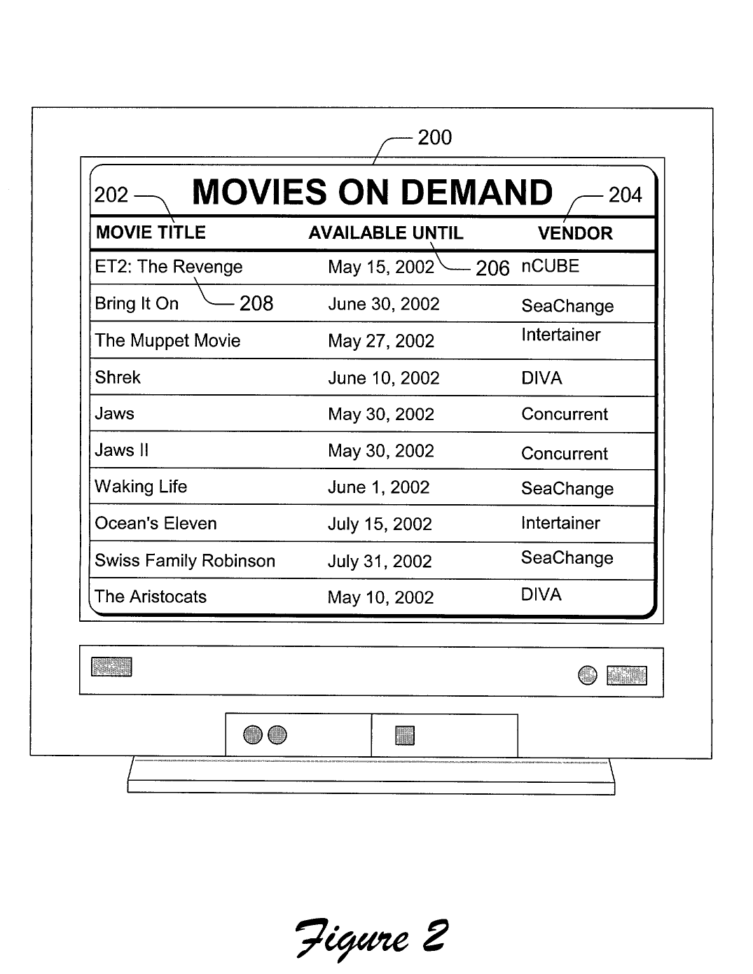

FIG. 2 illustrates an exemplary video-on-demand EPG user interface display listing available on-demand media content. The display 200 is generated by client device 106 based on EPG data 116. The displayed list of available movies includes a list of movie titles 202 with associated VOD vendors 204 and additional data which may include an available until date 206. A viewer may select a specific movie title from the displayed list, such as “ET2: The Revenge” 208 to display additional details associated with the selected media content.

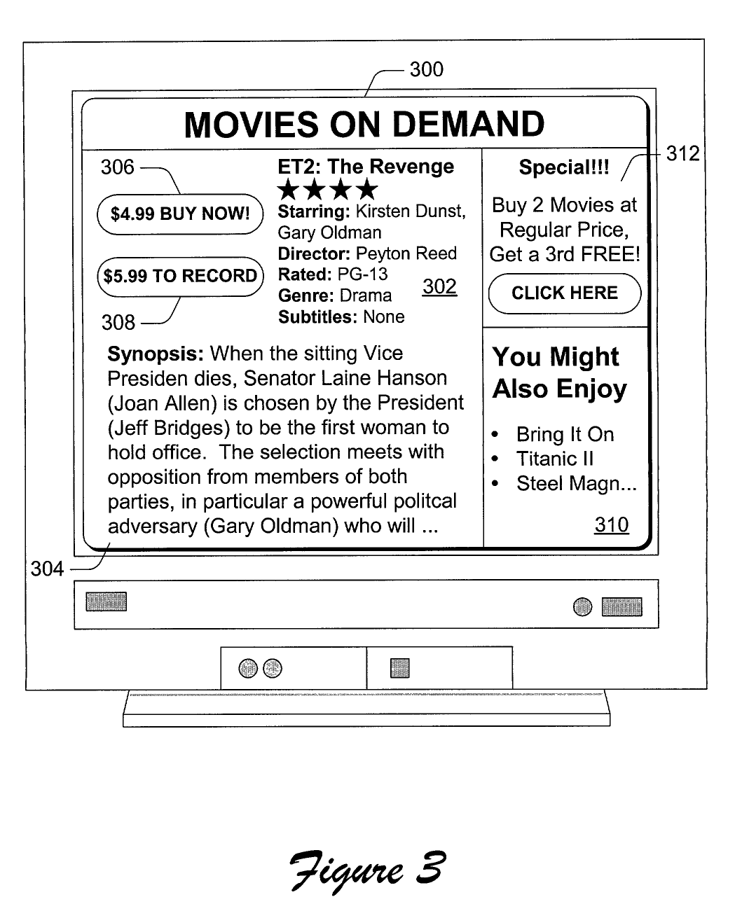

FIG. 3 illustrates an exemplary video-on-demand EPG user interface display of selected media content details. Client device 106 generates the media content details display 300 when a user selects an on-demand product, such as a movie, from an EPG, as described with reference to FIG. 2. The display 300 includes a details area 302, a synopsis area 304, a selectable purchase button 306, a selectable record button 308, an advertisement area 310, and a special offers area 312.

The details area 302 may display, for example, the title, a rating, a list of actors, the name of the director, and a genre. The specific details displayed in the details area 302 may vary depending on the EPG data 116 associated with the selected movie 208. In one implementation, one or more of the items listed in the details area 302 is selectable. For example, a television viewer may select the name of an actor listed in the details area 302. Selecting an item in the details area 302 causes the user interface to display a list of available on-demand media content associated with the selected item. For example, when a viewer selects the name of an actor, a list of available movies in which the actor plays is displayed.

The synopsis area 304 displays a short description of the plot of the selected media content.

The selectable purchase button 306 allows the viewer to indicate that they would like to purchase the media content for viewing. The selectable record button 308 allows the viewer to indicate that they would like to purchase the media content for recording. For example, if a viewer purchases a movie for viewing, there may be a time limit (e.g., four hours) during which the viewer may view the media content. If the viewer is unable to view the media content during the purchase time limit, then the viewer may purchase the media content (e.g., through a client device implemented as a digital video recorder), possibly at a higher price, with the ability to record the media content.

The advertisements area 310 displays advertisements 120 associated with the selected media content 208. Example advertisements 120 may include recommendations for other on-demand media content based on any number of criteria, such as geographic location, viewer subscriptions, viewing patterns of the viewer, viewing patters of other viewers, and related media content such as movie sequels. Recommended media content may be available from any combination of VOD vendors 102. Other advertisements may include previews and/or trailers associated with one or more movies.

The special offers area 312 displays packages and/or discounts 122 that are available to a television viewer. The packages and/or discounts displayed may be based on any number of criteria, such as television viewer purchase history and VOD vendor promotions. For example, a media distribution system 104 may present an offer for a free on-demand movie with the purchase of two on-demand movies to a television viewer with a history of infrequent on-demand movie purchases. Additionally, a VOD vendor 102 may offer a special that the media distribution system 104 in turn offers to the television viewers. When a viewer selects an offered package or discount, the terms of the offer are stored and automatically tracked as the user purchases on-demand media content. For example, when a viewer selects a discount offering a free movie with the purchase of two movies, the system tracks the viewer purchases and doesn't charge the viewer for the third movie purchased.

Exemplary Media Distribution System

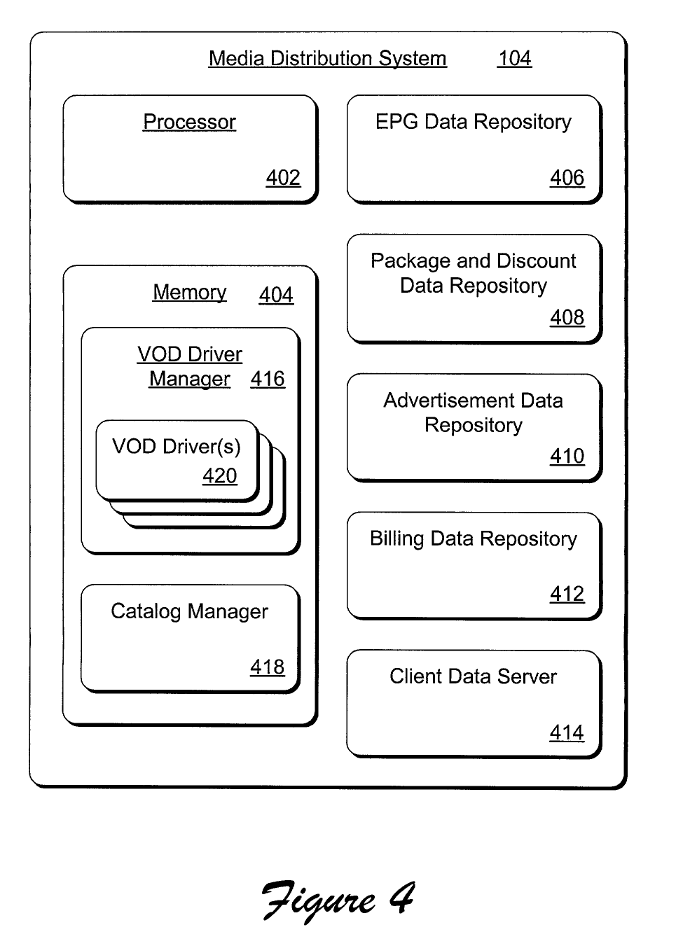

FIG. 4 illustrates selected components of an exemplary media distribution system 104. Media distribution system 104 includes a processor 402, a memory 404, data repositories 406-412, and a client data server 414. A VOD driver manager 416 and a catalog manager 418 are stored in memory 404 and executed on processor 402. The VOD driver manager 416 maintains VOD vendor-specific drivers 420 that facilitate communication between the media distribution system 104 and the VOD vendors 102. The VOD driver manager 416 provides extensibility within the system in that support for an additional VOD vendor can be added by installing a VOD driver 420 within the VOD driver manager 416 to facilitate communication between the new VOD vendor and the media distribution system 104. Each VOD driver 420 managed by the VOD driver manager 416 establishes a format for program data 110 received from a VOD vendor 102 and supports the conversion of the program data into a common format.

The catalog manager 418 packages the program data 110 that is received from the VOD vendors 102 and stores the packaged program data in the EPG data repository 406. The catalog manager 418 stores advertisements received as part of program data 110 (e.g., movie previews and/or trailers) in the advertisement data repository 410. In addition, the catalog manager 418 may generate ads 120 (e.g., recommendations) and/or packages and discounts 122, which are stored in the advertisement data repository 410 and the package and discount data repository 408, respectively.

The billing data repository 412 stores purchase history data which may be used to generate viewing recommendations. In one implementation, viewers may choose whether or not to allow the media distribution system 104 to maintain data describing the viewer's purchase history. In one implementation, if a user chooses to allow their purchase history data to be gathered, then when a user purchases on-demand media content, a record of that purchase is stored in the billing data repository.

Client data server 414 distributes data stored in the EPG data repository 406, the package and discount data repository 408, and advertisement data repository 410, and the billing data repository 412 to the client devices 106.

Exemplary VOD Driver Data Format

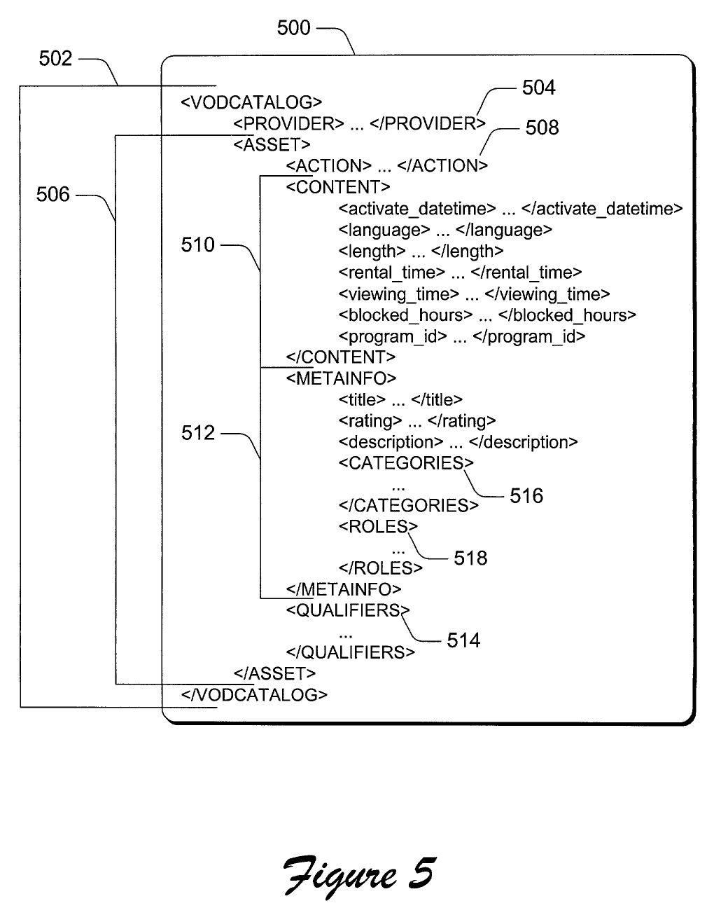

FIG. 5 illustrates an exemplary common format 500 for structuring program data 110 received from VOD vendors 102. The data format 500 is shown implemented based on an XML schema. The <VODCATALOG> tags 502 indicate one or more entries associated with available media-on-demand products. The <PROVIDER> tags 504 indicate an identifier associated with a VOD vendor 102 that supplied program data 110 associated with a described media-on-demand product. For example, the provider entry:

<PROVIDER> VendorX</PROVIDER>

indicates that the program data to follow was provided by the VOD vendor, “VendorX”.

The <ASSET> tags 506 indicate the received program data 110 associated with a described media-on-demand product received from the VOD vendor 102 identified as indicated by the <PROVIDER> tags 504. Multiple sets of <ASSET> tags 506 may be associated with a set of <PROVIDER> tags 504, indicating that the identified VOD vendor supplied program data 110 describing multiple media-on-demand products.

A single media-on-demand product (i.e., asset) is described in terms of an action (indicated by the <ACTION> tags 508), content data (indicated by the <CONTENT> tags 510), metadata (indicated by the <METAINFO> tags 512), and qualifiers (indicated by the <QUALIFIERS> tags 514).

The <ACTION> tags 508 indicate an action to be performed in association with the described asset. Example actions may include ADD, REMOVE, and UPDATE. The ADD action indicates that the associated program data 110 is to be added to the EPG data 116, indicating that the described asset is available from the identified VOD vendor as media-on-demand. The REMOVE action indicates that the associated program data 110 is to be removed from the EPG data 116, indicating that the described asset is no longer available from the identified VOD vendor. The UPDATE action indicates that the associated program data 110 is to be used to update any existing EPG data 116 associated with the described media-on-demand product.

The <CONTENT> tags 510 indicate data associated with the available media content. For example, content data may include an activation date/time, a language, a length, a rental time, a viewing time, a blocked hours indicator, and a program ID, as shown below:

<CONTENT>

<activate_datetime>2001-01-01</activate_datetime>
<language>English</language>
<length>147</length>
<rental_time>4.000000</rental_time>
<viewing_time>4.000000</viewing_time>
<blocked_hours>000000000000000000000000</blocked_hours>
<program_id>524290</program_id>

</CONTENT>

The <activate_datetime> tags indicate the date or date/time at which the described media content will be available from the indicated VOD vendor. In the above example, the described media content will become available on Jan. 1, 2001. The <language> tags indicate the primary language of the media content. In the above example, the primary language is English. The <length> tags indicate the duration of the media content, preferably in minutes. In the above example, the describe media content has a duration of 147 minutes. The <rental_time> tags indicate the amount of time after purchasing the media-on-demand product that a viewer will be able to access the media content from the VOD vendor. The <viewing_time> tags indicate the amount of time that a viewer may spend actually viewing the purchased media content. In the above example, both the rental time and the viewing time are four hours. The <blocked_hours> tags indicates daily time periods during which the described media content will not be available for download to a client device 106 from the VOD vendor 102. In one implementation, the blocked hours indicator is made up of 24 digits, each representing one hour of a day, beginning at 12:00 am. A value of 0 indicates that delivery of the media content is not blocked; a value of 1 indicates that delivery of the media content is blocked, and thus, not available during the hour indicated. In the above example, there are not blocked hours associated with the described media content. The <program_id> tags indicate an identifier that the VOD vendor 102 associates with the described media content. In the above example, the program ID is “524290”.

The <METAINFO> tags 512 indicate metadata that describes the available media content. For example, as shown below, metadata may include a title, a rating, a description, one or more categories (indicated by the <CATEGORIES> tags 516>, and one or more roles (indicated by the <ROLES> tags 518).

<METAINFO>

<title language=“English”>Traffic</title>
<rating rating_system=“MPAA”>R</rating>
<description language=“English”>A conservative judge is
appointed by the President to spearhead America's escalating war
against drugs, only to discover that his teenage daughter is a heroin
addict.</description>
<CATEGORIES language=“English”>

<primary_category>Movie</primary_category>
<secondary_category>New Release</secondary_category>
<secondary_category>Drama</secondary_category>

</CATEGORIES>
<ROLES language=“English”>

<actors>Michael Douglas</actors>
<actors>Catherine Zeta-Jones</actors>
<actors>Dennis Quaid</actors>
<actors>Benicio Del Toro</actors>
<actors>Don Cheadle</actors>
<directors>Steven Soderbergh</directors>

</ROLES>

</METAINFO>

The <title> tags indicate the title of the described media content, for example, “Traffic”. The language designator within the tag indicates the language in which the tagged value is specified; “English” in the above example. The <rating> tags indicate a rating associated with the described media content, for example, “R”. The rating system designator within the tag indicates the rating system that is associated with the tagged value; “MPAA” in the above example. The <description> tags indicate a description associated with the described media content. The language designator within the tag indicates the language in which the tagged description is given; “English” in the above example.

The <CATEGORIES> tags 516 indicate a set of tags that identity one or more categories associated with the described media content. In the above example, the media content is associated with one primary category (i.e., “Movie”) and two secondary categories (i.e., “New Release” and “Drama”).

The <ROLES> tags 518 indicate a set of tags that identify one or more persons associated with the media content and the way in which they are associated. In the above example, Michael Douglas, Catherine Zeta-Jones, Dennis Quaid, Benicio Del Toro, and Don Cheadle are identified as actors and Steven Soderbergh is identified as a director.

The <QUALIFIERS> tags 514 indicate additional data associated with the availability of the described media content. Example qualifier data is shown below:

<QUALIFIERS>

<qualifier name=“scrambled” language=“English”>TRUE</
qualifer>
<qualifier name=“provider” language=“English”>USA Films</
qualifier>
<qualifier name=“price” language=“English” price=“3.99”
tax=“0.00” unit=“$”>Hit Movies></qualifier>
<qualifier name=“copyprice” language=“English” price=“1.00”
tax=“0.00” unit=“$”> Standard</qualifier>
<qualifier name=“vcrcommandprice” language=“English”
price=“1.00” tax=“0.00” unit=“$”>Standard</qualifier>
<qualifier name=“vcrcommandsallowed”
language=“English”>TRUE</qualifier>
<qualifier name=“previewperiod” language=“English”>30</
qualifier>
<qualifier name=“release_year” language=“English”>2000</
qualifier>
<qualifier name=“rentaltime” language=“English”>1</qualifier>
<qualifier name=“deactivate_datetime”
language=“English”>2001-12-07</qualifier>
<qualifier name=“type” language=“English”>Video MPEG</
qualifier>
<qualifier name=“conversion” language=“English”>Conversion</
qualifier>

</QUALIFIERS>

The scrambled qualifier indicates whether or not the offered media content is scrambled.

The provider qualifier indicates the studio that owns the movie, such as USA Films.

The price qualifier indicates the price that will be charged to view the movie.

The copy price qualifier indicates the price that will be charged to record the movie using, for example, a VCR or DVR.

The VCR command price qualifier indicates the price that will be charged to view the movie with the ability to control the movie with VCR controls, for example, fast-forward, rewind, and pause.

The VCR commands allowed qualifier indicates whether or not VCR commands are available with the purchase of the media content. VCR commands include, for example, the ability to fast-forward, rewind, and pause.

The preview period qualifier indicates a period of time during which the user can view the movie without being charged. For example, if a movie has a preview period of 5 minutes, a user can begin viewing the movie and cancel the 12 viewing within the first 5 minutes without being charged for the movie.

The release year qualifier indicates the year in which the movie was released.

The rental time qualifier indicates a time period during which a user may view a purchased movie. For example, a user may be able to view a movie for three days after purchase.

The deactivate date/time qualifier indicates a date and time after which the movie will no longer be available.

The type qualifier indicates the format of the movie, such as MPEG.

The conversion qualifier indicates a format conversion that was applied to the movie, such as, no conversion, video encode, audio encode, TIFF-to-MPEG, or WAV-to-AIFC.

Exemplary EPG Data Repository

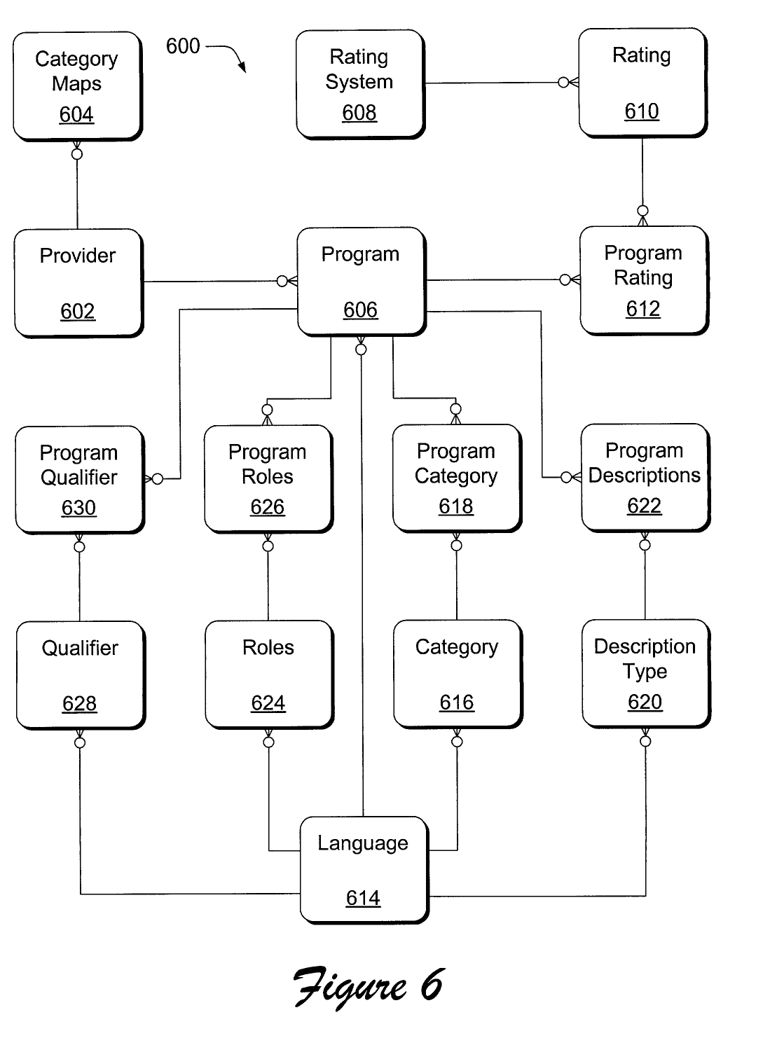

FIG. 6 illustrates selected components of an exemplary EPG data repository schema. EPG data repository 406 stores, in a data structure 600, data that describes available media content. The available media content may include media content scheduled for broadcast as well as media content available on-demand. Data tables 602-630 represent data that can be stored in EPG data repository 406.

The provider table 602 stores data that is associated with a media content provider (e.g., a VOD vendor 102). One record is stored in the provider table 602 for each VOD vendor 102 that is supported by the media distribution system 104. The provider table 602 may include, for example, the following data fields:

| | |
|---|---|
| Provider ID | Alternate Password |
| Provider Name | Staging Directory |
| Provider Type | Initialize Package Name |
| Provider Prefix | Fetch Type |
| Contact ID | Data Days |
| Source URL | Data Per Day |
| Alternate URL | Feed Time |
| Last Update | Source Dir |
| Source User Name | Archive Dir |
| Source Password | File Names |
| Alternate User Name | |

The category maps table 604 stores a mapping between media content provider categories and EPG system categories. For example, one VOD vendor may categorize recently released movies as “New Releases” while a second VOD vendor 102 may categorize recently release movies as “Now Available”. To facilitate consistent categorization of media content across VOD vendors, the category maps table 604 may map both the “New Releases” category from the first VOD vendor and the “Now Available” category from the second VOD vendor to a system category, “New Movies”. The category maps table 604 supports mapping primary and secondary category combinations. The category maps table 604 may include, for example, the following fields:

Provider ID

Provider Primary

Provider Secondary

System Primary

System Primary ID

System Secondary

System Secondary ID

The program table 606, which stores data associated with a particular media content, may include, for example, the following data fields:

| | |
|---|---|
| Program ID | Surround Sound |
| Provider ID | Seasonal |
| Release Year | Infomercial |
| Release Country | Animated |
| Length | Letter Box |
| Black And White | Preview ID |
| Video | Viewing Time |
| Rental Time | Source Type |
| Blocked Hours | Show Type |
| Activate Date Time | Language ID |
| Deactivate Date Time | |

The Provider ID maps to a Provider ID in the Provider table 602, which identifies the VOD vendor that can supply the described media content. The Language ID maps to a Language ID in the Language table 614, described in further detail below.

The rating system table 608 stores data that identifies rating authorities. The Motion Picture Association of America (MPAA) is an example rating authority. The rating system table 608 may include, for example, the following data fields:

Rating System ID

Rating System Name

Rating System Country Code

Description

The rating table 610, which stores ratings associated with the rating authorities identified in the rating system table 608, may include, for example, the following data fields:

Rating ID

Rating System ID

Rating

The program rating table 612, which associates one or more ratings with one or more programs, may include, for example, the following data fields:

Program ID

Rating ID

The language table 614, stores data that identifies languages associated with one or more programs. The Language ID from the language table 614 is reference in the program table 606, the category table 616, the description type table 620, the roles table 624, and the qualifier table 628. The language table 614 may include, for example, the following data fields:

Language ID

Language Name English

Language Name Native

The category table 616, stores category data that may be associated with media programs. Example categories may include drama, comedy, new releases, mystery, and horror. The category table 616 may be used to relate multiple categories in a hierarchical structure. The category table 616 may include, for example, the following data fields:

Category ID

Language ID

Category Name

Parent ID

Category Level

The program category table 618, which associates one or more categories with one or more programs, may include, for example, the following data fields:

Program ID

Category ID

The description type table 620 stores data that identifies type of descriptions that may be associated with media content. Example description types may include a title, a short plot description, and a long plot description. The description type table may include, for example, the following data fields:

Description Type

Language ID

Name

Presentation Name

The program descriptions table 622, which associates one or more descriptions with one or more programs, may include, for example, the following data fields:

Program ID

Description Type

Description Data

The roles table 624 stores data that identifies roles that may be associated with media content. Example roles may include actor, director, producer, and screen writer. The roles table 624 may include, for example, the following data fields:

Role ID

Language ID

Description

The program roles table 626, which associates one or more roles with one or more programs, may include, for example, the following data fields:

Program ID

Role ID

Name

The qualifier table 628 stores data that identifies other data that may be associated with media content. Associated qualifiers may vary across described media content, and new qualifiers can be added to the qualifier table 628 to support the storage of additional data not otherwise supported by the data structure 600. The qualifier table 628 may include, for example, the following data fields:

Qualifier ID

Language ID

Name

The program qualifier table 630, which associates one or more qualifiers with one or more programs, may include, for example, the following data fields:

Program ID

Qualifier ID

Value

Exemplary Client Device

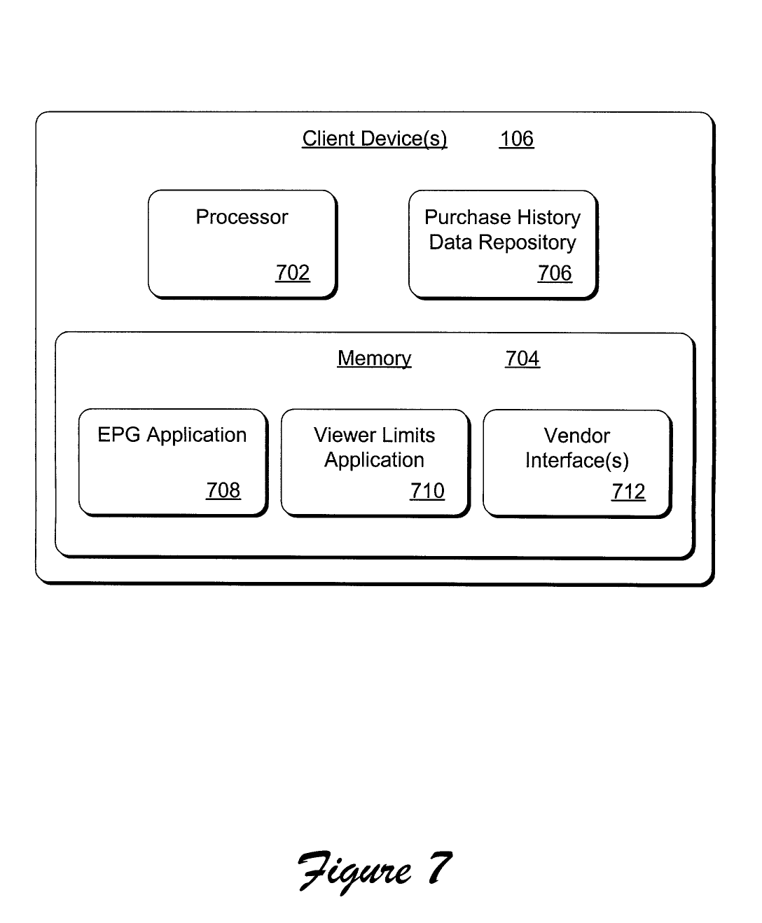

FIG. 7 illustrates selected components of an exemplary client device 106. Client device 106 includes a processor 702, a memory 704, and a purchase history data repository 706. An EPG application 708, a viewer limits application 710, and one or more vendor interfaces 712 are stored in memory 704 and executed on processor 702.

Purchase history data repository 706 stores data associated with viewer purchases of on-demand media content. The data stored in the purchase history data repository 706 may be used to generate billing reports, or may be transmitted to the media distribution system 014 or the VOD vendors 102 for billing processing.

EPG application 708 provides an interactive user interface display of EPG data that is stored in the EPG data repository 406 on the media distribution system 104. The EPG application 708 can query the EPG data repository 406, display an interactive EPG (as shown in FIG. 2), and display additional information about media content in response to viewer selections within the EPG (as shown in FIG. 3).

The viewer limits application 710 enables a television viewer to set limits that are then automatically enforced by the client device. A viewer may set, for example, purchase limits and parental control limits. Purchase limits may specify a maximum number of on-demand media content that may be purchased within a given time period (e.g., a month), or may specify a maximum dollar amount that may be spent on on-demand media content. Parental control limits may specify a maximum standard rating, such as PG-13. Based on the specified parental control limit, the client device will not permit a viewer to purchase media content with a rating higher than PG-13, for example, R-17.

Vendor interfaces 712 are vendor-specific applications that enable the client device 106 to communicate with the VOD vendors 102 to request and receive on-demand media content.

Methods for Multi-Vendor VOD Support

Multi-vendor VOD support may be described in the general context of computer-executable instructions, such as application modules, being executed by a computer. Generally, application modules include routines, programs, objects, components, data structures, etc. that perform particular tasks or implement particular abstract data types. Multi-vendor VOD support may also be implemented in distributed computing environments where tasks are performed by remote processing devices that are linked through a communications network. In a distributed computing environment, application modules may be located in both local and remote computer storage media including memory storage devices.

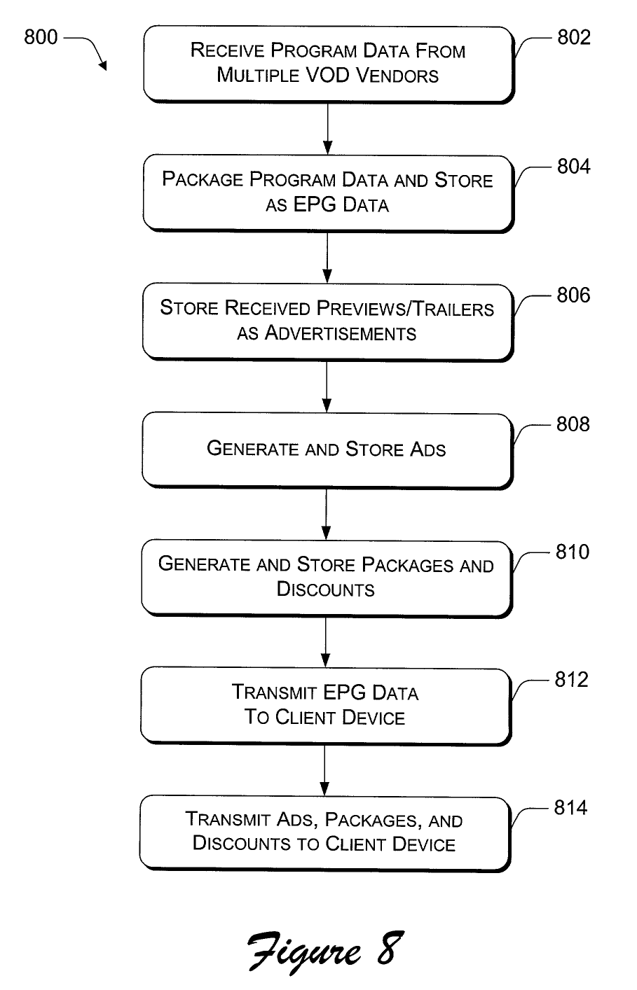

FIG. 8 illustrates a method 800 for packaging program data received from multiple VOD vendors for distribution as EPG data, advertisements, packages, and discounts to one or more client devices. The order in which the method is described is not intended to be construed as a limitation. Furthermore, the method can be implemented in any suitable hardware, software, firmware, or combination thereof. Where applicable, the method is described with reference to components shown in FIGS. 1-7.

At block 802, a media distribution system 104 receives program data 110 from multiple VOD vendors 102 through a VOD driver 420 managed by VOD driver manager 416. The program data 110 received from the multiple vendors 102 may vary in format.

At block 804, the catalog manager 418 of media distribution system 104 converts the program data 110 to a common format, such as the data structure described with reference to FIG. 6. The catalog manager 418 packages the program data 110 and stores the packaged program data as EPG data 116 in the EPG data repository 406.

In one implementation, the vendor-specific data format described with reference to FIG. 5 is mapped to the structure of EPG data repository 406 described with reference to FIG. 6. The identifier associated with a VOD vendor 102 that is indicated by the <PROVIDER> tags 504 is compared against the Provider Name field in the provider table 602 to determine the provider ID associated with the VOD vendor 102 that supplied the program data 110.

The data that is designated within the <CONTENT> tags 510 is mapped to fields in the program table 606. For example, the data designated by the <activate_datetime> tags is stored in the activate_datetime field.

The data designated by the <language> tags is compared against data stored in the languagename_english and/or the language_name_native fields in the language table 614 to determine a language ID which is then stored in the language ID field in the program table 606.

The data designated by the <length> tags, the <rental_time> tags, the <viewing_time> tags, and the <blocked_hours> tags are stored in the length field, the rental time field, the viewing_time field, and the blocked_hours field, respectively, in the program table 606.

The data designated by the <program_id> tags is appended to the data stored in the provider_prefix field of the record in the provider table 602 that corresponds to the VOD vendor 102 that supplied the program data 110 (based on the provider ID). The resulting data (i.e., the provider_prefix concatenated with the supplied provider_id) is stored in the program table 606 as the program ID.

The data that is designated within the <METAINFO> tags 512 is mapped to fields in the program descriptions table 622, the program rating table 612, the program category table 618, and the program roles table 626. For example, the data designated by the <title> tags is stored in the program descriptions table 622. The description_type field indicates that the data stored is a title, and the description_data field stores the title designated by the <title> tags. The language indicated within the <title> tag is used to determine, based on values stored in the language table 614, the language ID that is stored in the program descriptions table 622.

Similarly, the data that is designated by the <description> tags is also stored in the description_data field of the program descriptions table 622. The corresponding data in the description_type field indicates that the data is a description (e.g., a short description or a long description). As with the <title> tags, the language indicated within the <description> tag is used to determine, based on values stored in the language table 614, the language ID that is stored in the program descriptions table 622.

The data that is designated by the <rating> tags is stored in the program rating table 612. The rating system indicated within the <rating> tag is compared against data stored in the rating_system_name field of the rating system table 608 to determine a rating system ID. The determined rating system ID and the rating value designated by the <rating> tags is compared against data stored in the rating system ID and the rating fields of the rating table 610 to determine a rating ID. The determined rating ID is stored with the program ID in the program rating table 612.

The data that is designated within the <CATEGORIES> tags 516 is mapped to fields in the program category table 618. For example, the primary category specified by the <primary_category> tags in combination with each secondary category specified by a set of <secondary_category> tags are compared against the provider primary and provider secondary fields of the category maps table 604 to determine the system primary ID and system secondary ID combination(s). The system primary ID and any determined system secondary IDs are stored with the provider ID in the program category table 618.

The data that is designated within the <ROLES> tags 518 is mapped to fields in the program roles table 626. For example, the language designated within the <ROLES> tag 518 is compared against data stored in the language table 614 to determine an associated language ID. The tag value (e.g., “actors” or “directors” in the example above with reference to FIG. 5) and the determined language ID are compared against the description and the language ID fields, respectively, in the roles table 624 to determine a role ID. The determined role ID and the tagged value (e.g., the name of an actor) are stored in the role ID and name fields, respectively of the program roles table 626.

The data that is designated within the <QUALIFIERS> tags 514 is mapped to fields in the program qualifier table 630. For each specified qualifier, the language specified in the tag is compared against data in the language table 614 to determine a language ID. The determined language ID and the name specified in the tag are compared against the language ID and name fields in the qualifier table 628 to determine a qualifier ID. Next, the tagged value is stored in the value field of the program qualifier table 630 with the determined qualifier ID and the associated program ID.

At block 806, after converting the received program data 110 to EPG data 116, the catalog manager 418 of media distribution system 104 extracts out advertisement data from the received program data 110. Advertisement data may include any received previews and/or trailers. The catalog manager 418 stores the extracted advertisement data in the advertisement data repository 410.

At block 808, the catalog manager 418 of media distribution system 104 generates advertisements 120 and stores the ads in the advertisement data repository 410. Advertisements 120 may include recommendations for on-demand media content. The generated advertisements may be based on program data and/or advertisement data received from one or more vendors.

The advertisements stored in the advertisement data repository 410 may be targeted in association with one or more programs based, for example, on the actors, directors, and/or categories associated with the program.

At block 810, the catalog manager 418 of media distribution system 104 generates packages and/or discounts 122 associated with on-demand media content. Example packages may represent groups of media content (possibly from multiple vendors) offered as a single unit and media-on-demand subscriptions. Example discounts may include buy two get one free offers. The catalog manager 418 stores the packages and/or discounts 122 in the package and discount data repository 408.

At block 812, the client data server 414 of media distribution system 104 transmits at least a portion of the EPG data 116 from EPG data repository 406 to one or more client devices 106. In one implementation, the EPG data that is transmitted may be determined based on a query or request received from the client device 106.

At block 814, the client data server 414 of media distribution system 104 transmits at least a portion of the ads 120 and the packages/discounts 122 from the advertisement data repository 410 and the package and discount data repository 408, respectively, to one or more client devices 106. In one implementation, the ads, packages, and discounts that are transmitted may be determined based on a query or request received from the client device 106.

Method for Viewer Purchase of On-Demand Media Content

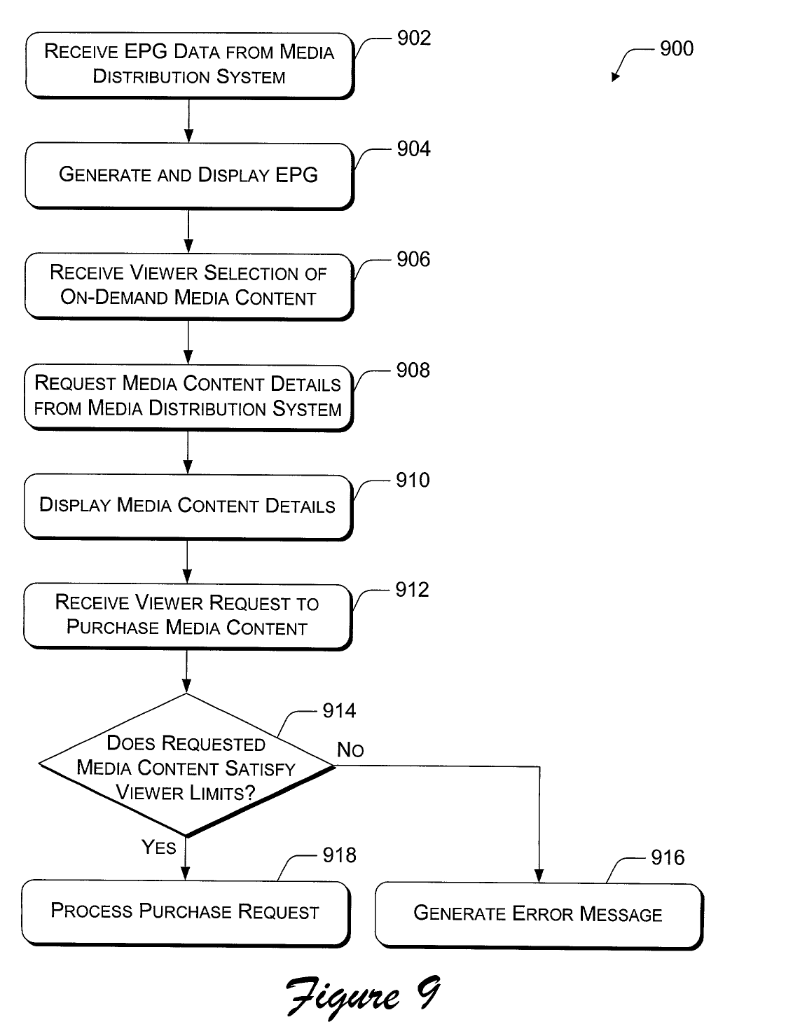

FIG. 9 illustrates a method 900 for enabling a television viewer to purchase on-demand media content. The order in which the method is described is not intended to be construed as a limitation. Furthermore, the method can be implemented in any suitable hardware, software, firmware, or combination thereof. Where applicable, the method is described with reference to components shown in FIGS. 1-7.

At block 902, EPG application 708 of client device 106 receives EPG data 116 from media distribution system 104.

At block 904, the EPG application 708 generates and displays an EPG (similar to the EPG display shown in FIG. 2) using the EPG data received as described in block 902.

At block 906, the EPG application 708 receives an indication that a viewer has selected an on-demand media content entry from the displayed EPG For example, the user selects a listing for a movie that is available for purchase as a video-on-demand, as described with reference to FIG. 2.

At block 908, the EPG application 702 queries the media distribution system 104 for additional data associated with the selected media content. The additional data associated with the selected media content may include additional EPG data stored in the EPG data repository 406, packages and discounts stored in the package and discount data repository 408, and/or advertisements stored in the advertisement data repository 410.

At block 910, the EPG application 708 displays the received media content details, for example, as described with reference to FIG. 3.

At block 912, the EPG application 708 receives a viewer request to purchase the selected media content. For example, the EPG application 708 receives an indication that a viewer has selected the purchase button 306 or the record button 308 as described with reference to FIG. 3.

At block 914, the viewer limits application 710 determines whether or not purchase of the selected media content is allowable, based on any viewer-specified purchase or parental control limits.

If it is determined that purchase of the selected media content would violate a user-specified limit, then at block 916, an error message is generated to inform the viewer of the limit violation.

If it is determined that purchase of the selected media content would not violate any user-specified limits, then at block 918, the client device 106 processes the purchase request.

Method for Processing Viewer-Submitted Purchase Request

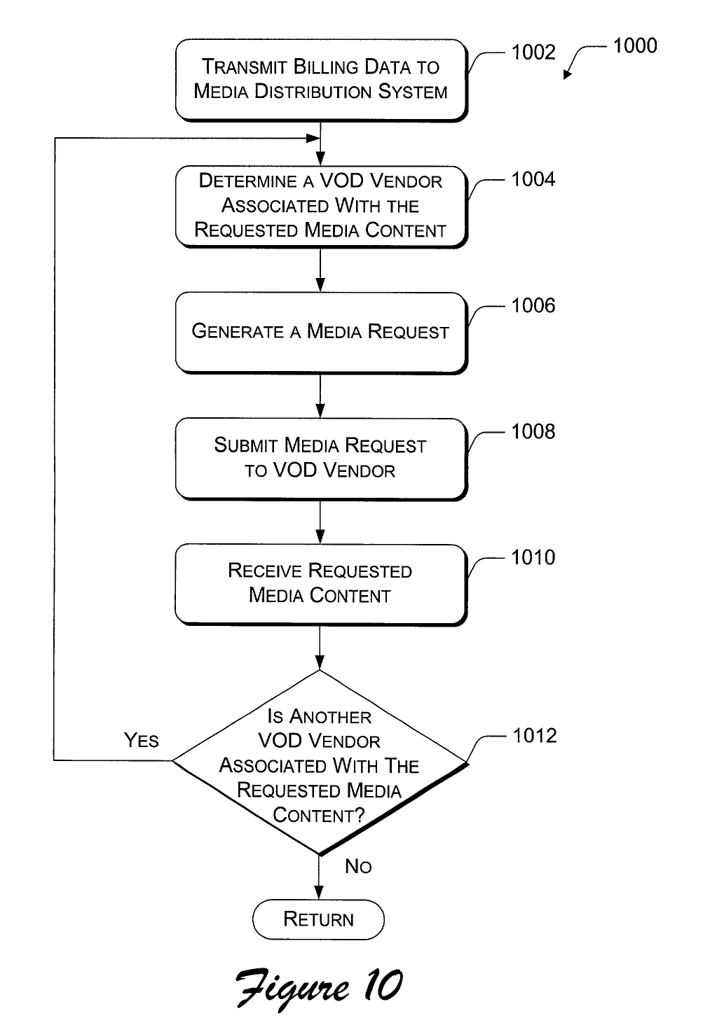

FIG. 10 illustrates a method 1000 for processing a viewer-submitted request to purchase on-demand media content. The order in which the method is described is not intended to be construed as a limitation. Furthermore, the method can be implemented in any suitable hardware, software, firmware, or combination thereof. Where applicable, the method is described with reference to components shown in FIGS. 1-7.

At block 1002, client device 106 transmits billing data to the media distribution system 104. The billing data may include information that identifies the requested media content, the vendor from which the media content is available, a purchase price, and any associated discounts or packages. The media distribution system distributes the billing data to the appropriate VOD vendors 102 according to a billing schedule. In an alternate embodiment, the client device transmits the billing data directly to the one or more associated VOD vendors 102.

At block 1004, the client device 106 determines a VOD vendor 102 that is associated with the requested media content.

At block 1006, the vendor interface 712 that is associated with the VOD vendor 102 determined in block 1004 generates a media request 126.

At block 1008, the vendor interface 712 submits the media request 126 to the VOD vendor 102.

At block 1010, the client device 106 receives the requested media content from the VOD vendor 102.

At block 1012, the client device 106 determines whether there are additional VOD vendors associated with the requested media content, for example, in the case of a viewer purchasing a package that includes media content from multiple VOD vendors.

If there are additional VOD vendors associated with the requested media content, the method continues repeats, beginning at block 1004.

Conclusion

Although the systems and methods have been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A media distribution system comprising:
a processor;
a memory;
media vendor drivers stored in the memory and executed on the processor to receive data from multiple on-demand media vendors; and
a client data server that bundles the data from the multiple on-demand media vendors and transmits the data to one or more client devices.

2. The media distribution system as recited in claim 1, further comprising a data repository that stores the data that is received from the multiple on-demand media vendors.

3. The media distribution system as recited in claim 1, further comprising a catalog manager stored in memory and executed on the processor to process the data received from the multiple media vendors to produce electronic program guide data that contains data from the multiple on-demand media vendors.

4. The media distribution system as recited in claim 1, further comprising a data repository that stores data pertaining to at least one of packages and discounts associated with on-demand media content available from the multiple on-demand media vendors.

5. The media distribution system as recited in claim 1, further comprising a data repository that stores advertisements associated with on-demand media content available from the multiple on-demand media vendors.

6. The media distribution system as recited in claim 1, further comprising a data repository that stores data associated with viewer purchases of on-demand media content from the multiple on-demand media vendors.

7. A media distribution system comprising:
media vendor drivers configured to receive program data from multiple on-demand media vendors;
a catalog manager configured to generate electronic program guide data based on the program data; and
a client data server configured to transmit the electronic program guide data to one or more client devices.

8. The media distribution system as recited in claim 7, further comprising an advertisement module configured to generate advertisements associated with the electronic program guide data.

9. The media distribution system as recited in claim 8, wherein an advertisement comprises a recommendation for a second on-demand media content associated with a first on-demand media content.

10. The media distribution system as recited in claim 9, wherein the recommendation is based on a media-on-demand purchase history associated with at least one viewer.

11. The media distribution system as recited in claim 9, wherein the recommendation is based on ratings associated with multiple media-on-demand products.

12. The media distribution system as recited in claim 7, further comprising a packaging module configured to generate electronic program guide data that represents a media-on-demand package, the media-on-demand package comprising media content available from any number of the multiple on-demand media vendors.

13. The media distribution system as recited in claim 7, further comprising a discounting module configured to generate electronic program guide data that represents discounted on-demand media content.

14. The media distribution system as recited in claim 7, further comprising a billing module configured to:
collect purchase data associated with on-demand media content purchases, the media content purchases through the one or more client devices and from the multiple on-demand media vendors; and
distribute the purchase data to the one or more client devices.

15. The media distribution system as recited in claim 7, further comprising a billing module configured to:
collect purchase data associated with on-demand media content purchases, the media content purchases through the one or more client devices and from the multiple on-demand media vendors; and
distribute the purchase data to the multiple on-demand media vendors.

16. A system comprising:
multiple on-demand media vendors configured to transmit media content;
a client device configured to request and receive media content from the multiple media vendors; and
a server configured to maintain data that identifies on-demand media content available from the multiple media vendors and provide to the client device a combined listing of the media content that is available from the multiple media vendors.

17. A method comprising:
receiving data that describes multiple media-on-demand products that are available from multiple media vendors; and
distributing to a client device a combined list of the media-on-demand products that are available from the multiple media vendors.

18. The method as recited in claim 17, wherein the media-on-demand products comprise at least one of a movie, a television show, a song, and a music album.

19. The method as recited in claim 17, further comprising:
distributing to the client device a recommendation for another media-on-demand product associated with a particular media-on-demand product wherein the particular media-on-demand product is available from a first media vendor and the another media-on-demand product is available from a second media vendor.

20. The method as recited in claim 17, further comprising:
distributing to the client device an offer to purchase discounted media-on-demand products from any number of the multiple media vendors.

21. The method as recited in claim 17, further comprising:
generating a product identifier that represents a media-on-demand product, the media-on-demand product comprising a plurality of the media-on-demand products that are available from the multiple media vendors; and
distributing the product identifier to the client device as part of the combined list of the media-on-demand products.

22. The method as recited in claim 17, further comprising distributing billing data to the client device that identifies on-demand media content purchased through the client device from the multiple media vendors.

23. One or more computer-readable media comprising computer executable instructions that, when executed, direct a computing system to:
receive program data associated with on-demand media content available from multiple media vendors;
process the program data to generate electronic program guide data; and
distribute the electronic program guide data to one or more client devices.

24. The one or more computer-readable media as recited in claim 23, further comprising computer executable instructions that, when executed, direct a computing system to:
generate advertisements associated with the electronic program guide data; and
distribute the advertisements to the one or more client devices.

25. The one or more computer-readable media as recited in claim 23, further comprising computer executable instructions that, when executed, direct a computing system to:
generate package data that describes packages of on-demand media content available from the multiple media vendors; and
distribute the package data to the one or more client devices.

26. The one or more computer-readable media as recited in claim 23, further comprising computer executable instructions that, when executed, direct a computing system to:
generate discount data that describes discounted on-demand media content available from the multiple media vendors; and
distribute the discount data to the one or more client devices.

27. The one or more computer-readable media as recited in claim 23, further comprising computer executable instructions that, when executed, direct a computing system to maintain billing data that describes client purchases of on-demand media content from the multiple media vendors.

28. The one or more computer-readable media as recited in claim 27, further comprising computer executable instructions that, when executed, direct a computing system to distribute the billing data to the one or more client devices.

29. The one or more computer-readable media as recited in claim 27, further comprising computer executable instructions that, when executed, direct a computing system to distribute the billing data to the multiple media vendors.

30. The one or more computer-readable media as recited in claim 23, further comprising computer executable instructions that, when executed, direct a computing system to install a vendor-specific driver associated with another media vendor, enabling the computing system to receive program data associated with on-demand media content available from the another media vendor.
